(19) United States
(12) Patent Application Publication
(10) Pub. No.: US 2026/0223157 A1
(43) Pub. Date: Jul. 30, 2026

(54) COMMUNICATION APPARATUS, COMMUNICATION METHOD, AND NON-TRANSITORY COMPUTER READABLE STORAGE MEDIUM

(71) Applicant: CANON KABUSHIKI KAISHA, Tokyo (JP)

(72) Inventor: Yuki Yoshikawa, Kanagawa (JP)

(21) Appl. No.: 19/634,247

(22) Filed: Mar. 31, 2026

Related U.S. Application Data
(63) Continuation of application No. PCT/JP2024/033072, filed on Sep. 17, 2024.

(30) Foreign Application Priority Data
Oct. 23, 2023 (JP) 2023-182053

(51) Int. Cl. H04W 74/00; H04W 84/12

(52) U.S. Cl. CPC H04W 74/002; H04W 84/12

(57) ABSTRACT

A communication apparatus that performs communication compliant with IEEE 802.11 standard series performs communication with another communication apparatus using a first channel access method that uses at least a Primary channel of one link and a second channel access method that, in a case where the Primary channel is in a busy state, uses a Non-Primary channel different from the Primary channel, and does not use the Primary channel, in a time period in which communication is being executed with a first communication apparatus using the second channel access method, in a case where the Primary channel becomes available for use, executing a first control, a second control, a third control, or fourth control.

### CROSS-REFERENCE TO RELATED APPLICATIONS

This application is a Continuation of International Patent Application No. PCT/JP2024/033072, filed September 17, 2024, which claims the benefit of Japanese Patent Application No. 2023-182053, filed October 23, 2023, both of which are hereby incorporated by reference herein in their entirety.

### BACKGROUND

### Field of the Technology

The present disclosure relates to data communication technology in a communication apparatus that can communicate using a communication link including a plurality of channels.

### Description of the Related Art

In recent years, with increases in the amount of data being communicated, the development of communication technology such as wireless local area network (LAN) has been proceeding. The Institute of Electrical and Electronic Engineers (IEEE) 802.11 standard series is known as the main communication standard for wireless LAN. The IEEE 802.11 standard series includes standards such as IEEE 802.11a/b/g/n/ac/ax/be, and the like. Development of the IEEE 802.11bn standard as the successor of the IEEE 802.11be standard is advancing with the purpose of further improving communication reliability. In the IEEE 802.11WG (Working Group) that is establishing the IEEE 802.11bn standard, the UHR SG is scheduled to set the purpose and scope of the standard, and the TGbn is scheduled to define the specific content of the technology to be included in the standard. Note that UHR SG is an abbreviation for the Ultra High Reliability Study Group. Also, TGbn is an abbreviation for the Task Group bn.

Technology for efficiently using the frequency resources in a communication method using a communication link including a plurality of channels is being looked into as one of the candidate technologies to include in the IEEE 802.11bn standard. For example, with the technology disclosed in U.S. Patent No. 11696353, in a case where a Primary Channel used for obtaining a transmission right cannot be used, another channel is used for communication.

### SUMMARY

The present disclosure provides technology for enabling frequency resources to be more efficiently used in a communication system using a communication link including a plurality of channels.

A communication apparatus according to an aspect of the present disclosure is a communication apparatus that performs communication compliant with IEEE 802.11 standard series, the communication apparatus including a communication unit that performs communication with another communication apparatus using a first channel access method that uses at least a predetermined Primary channel in one link and a second channel access method that, in a case where the Primary channel is in a busy state, uses a Non-Primary channel different from the Primary channel from among a plurality of channels included in the link and does not use the Primary channel; and a control unit that, in a time period in which communication is being executed with a first communication apparatus using the second channel access method, in a case where the Primary channel becomes available for use, executes a first control to transition an operating status of the communication apparatus for the Primary channel to a predetermined status, a second control to transition a status of the Primary channel to a predetermined status, a third control to transmit a predetermined signal to the first communication apparatus executing communication using the Non-Primary channel, or fourth control to end communication with the first communication apparatus executed using the second channel access method.

Features of the present disclosure will become apparent from the following description of embodiments with reference to the attached drawings.

### BRIEF DESCRIPTION OF THE DRAWINGS

FIG. 1 is a diagram illustrating a configuration example of a wireless communication system.

FIG. 2A is a schematic view illustrating an example of a time chart of when a communication apparatus transmits data.

FIG. 2B is a schematic view illustrating an example of a time chart of when a communication apparatus transmits data.

FIG. 3 is a diagram illustrating a hardware configuration example of a communication apparatus.

FIG. 4 is a diagram illustrating a functional configuration example of a communication apparatus.

FIG. 5 is a diagram illustrating an example of a time chart of when a signal is exchanged between the PCH and the NPCH.

FIG. 6 is a diagram illustrating an example of a flow indicating operations of a communication apparatus at the time of reception.

FIG. 7 is a diagram illustrating an example of a time chart of when a signal is exchanged between the PCH and the NPCH.

FIG. 8 is a diagram illustrating an example of a flow indicating operations of a communication apparatus at the time of reception.

FIG. 9 is a diagram illustrating an example of a time chart of when a signal is exchanged between the PCH, the NPCH, and another link.

FIG. 10 is a diagram illustrating an example of a flow indicating operations of a communication apparatus at the time of reception.

FIG. 11A is a diagram illustrating an example of a notification signal for notifying that the PCH has become available for use.

FIG. 11B is a diagram illustrating an example of a notification signal for notifying that the PCH has become available for use.

FIG. 11C is a diagram illustrating an example of a notification signal for notifying that the PCH has become available for use.

### DESCRIPTION OF THE EMBODIMENTS

### System Configuration

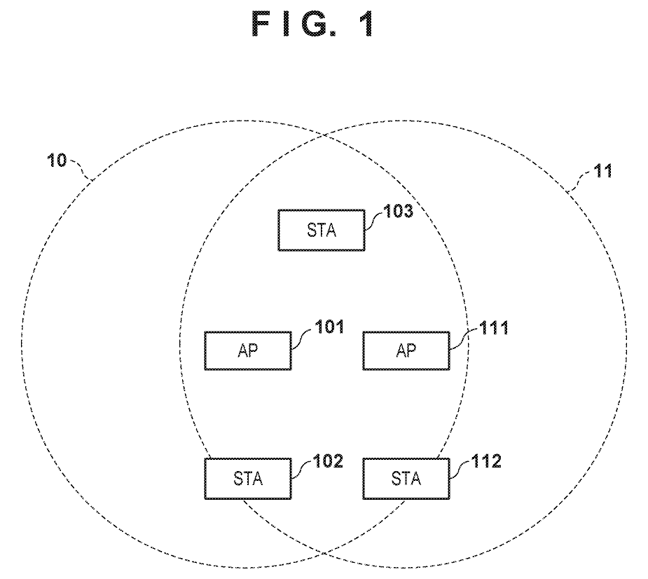

FIG. 1 illustrates a configuration example of a wireless communication system according to the present embodiment. The wireless communication system includes an access point (AP) 101, a station (STA) 102, and an STA 103, for example. The AP 101, the STA 102, and the STA 103 are each communication apparatuses that can execute wireless communication compliant with the IEEE 802.11 standard series. IEEE is an abbreviation for the Institute of Electrical and Electronics Engineers. FIG. 1 illustrates a configuration in which the STA 102 and the STA 103 join a network 10 established by the AP 101. The network 10 may be referred to as a Basic Service Set (BSS). In FIG. 1, a configuration in which one AP 101 and the two STAs, the STA 102 and the STA 103, exist is illustrated, but for both the AP and the STA, one or a plurality may exist. Also, in such an example, a plurality of STAs may be connected to one AP, or one STA may be connected to a plurality of APs. Note that in FIG. 1, a network 11 including an AP 111 and an STA 112 exists near the network 10 including the AP 101, the STA 102, and the STA 103. The AP 111 and the STA 112 are communication apparatuses that can execute wireless communication compliant with the IEEE 802.11 standard series in a similar manner to the AP 101, the STA 102, and the STA 103. For the AP 101, the STA 102, and the STA 103, the network 10 is the BSS that the respective apparatuses connect to and may be referred to as its own BSS. On the other hand, for the AP 101, the STA 102, and the STA 103, the network 11 is a network that may cause interference with its own BSS and may be referred to as an Overlapping BSS (OBSS). In the present embodiment, the AP 101, the AP 111, the STA 102, the STA 103, and the STA 112 may be referred to generically as a communication apparatus 100. Also, the AP 101 and the AP 111 may be simply referred to as an AP, and the STA 102, the STA 103, and the STA 112 may be simply referred to as an STA.

In the present embodiment, the communication apparatus 100 is configured to be able to execute a communication method compliant with the IEEE 802.11bn standard. The IEEE 802.11bn standard is a successor to the IEEE 802.11be standard with a goal of 46.08 Gbps (Giga bit per second) for the maximum transmission speed. A main feature of the IEEE 802.11bn standard is that it has a function of achieving high reliability communication, low latency, improvement in throughput when the communication traffic is congested, and the like. The wireless frame used in the communication method compliant with this standard may be referred to as an Ultra High Reliability (UHR) PPDU. PPDU is an abbreviation for a PLCP Protocol Data Unit, and PLCP is an abbreviation for a Physical Layer Convergence Protocol. Note that there is a possibility of the names UHR, IEEE 802.11bn, and the like being changed to a different name after the standard has finished being established. Also, it should be noted that the scope of the present specification and the claims attached to the present specification can be applied to a communication apparatus using any or all of the successors to the IEEE 802.11be standard. Also, the communication apparatus 100 may support at least any one of the legacy standards from before the IEEE 802.11bn standard. Legacy standards include IEEE 802.11a/b/g/n/ac/ax/be, for example. Also, the communication apparatus 100 may support other communication standards, such as Bluetooth (registered trademark), NFC, UWB, ZigBee, MBOA, and the like. Note that UWB is an abbreviation for Ultra Wide band, and MBOA is an abbreviation for Multi Band OFDM Alliance. Also, NFC is an abbreviation for Near Field Communication. UWB includes wireless USB, wireless 1394, WiNET, and the like. Also, the communication apparatus 100 may support wired LAN or similar communication standards. Examples of the AP include but are not limited to a wireless LAN router, a personal computer (PC), and the like. The AP may be an information processing apparatus such as a radio chip that can execute wireless communication that complies with the IEEE 802.11bn standard or the like. Examples of the STA include but are not limited to a camera, a tablet, a smartphone, a PC, a mobile phone, a video camera, a headset, and the like. The STA may be an information processing apparatus such as a radio chip that can execute wireless communication that complies with the IEEE 802.11bn standard or the like.

The communication apparatus 100 may communicate using wireless signals of frequency bands including the 2.4 GHz band, the 3.6 GHz band, the 5 GHz band, the 6 GHz band, or millimeter wave bands such as the 45 GHz band and the 60 GHz band. The frequency band used by the communication apparatus 100 is not limited to these examples and may be a Sub-1 GHz band or the like. Also, the communication apparatus 100 may communicate using bandwidth such as 20 MHz, 40 MHz, 80 MHz, 160 MHz, 320 MHz, 540 MHz, 640 MHz, 1080 MHz, and 2160 MHz. The bandwidth used by the communication apparatus 100 is not limited to these examples and may be 240 MHz, 4 MHz, or the like, for example. Note that in the IEEE 802.11 standard series, a frequency channel that uses the 20 MHz bandwidth is specified as the basic channel for the 2.4 GHz, 5 GHz, 6 GHz, and similar frequency bands. Also, in the standard, a plurality of usable channels are defined for each frequency band including the 2.4 GHz band, the 5 GHz band, and the 6 GHz band. Note that in the standard, the communication apparatus 100 can use a combination of a certain channel and another adjacent channel. Using a combination of a certain channel and another adjacent channel in this manner may be referred to as channel bonding. Also, a bundle of channels formed of one or two or more channels adjacent to one another may be referred to as a communication link (link). In other words, one link formed of two channels of the 20 MHz bandwidth may use the 40 MHz bandwidth. In the IEEE 802.11be standard, 320 MHz is scheduled to be specified as the maximum bandwidth that can be used for one link. Also, the signal transmitted in the bandwidth may be consecutive on the frequency axis or may be non-consecutive. Note that the AP and the STA may be an AP Multi-Link Device (MLD) and a STA MLD, respectively, that support Multi-Link in which communication is performed with a plurality of links simultaneously established. Simultaneously establishing a plurality of links between communication apparatuses and performing communication may be referred to as Multi-Link communication.

When transmitting a signal using the established link with the other communication apparatus, the communication apparatus 100 determines whether the signal can be transmitted by executing carrier sense. Carrier sense is an operation in which the communication apparatus 100 determines whether or not a signal exists on the channel that the communication apparatus 100 is trying to use for transmission. For example, the communication apparatus 100 measures the strength (receive signal strength) of the signal received on the channel and, in a case where the receive signal strength is greater than a predetermined threshold, determines that a signal exists on the channel (physical carrier sense). The receive signal strength may also be referred to as the Received Signal Strength Indicator (RSSI). Also, the communication apparatus 100 may determine whether or not a signal exists based on information such as a Duration field included in the signal received on the channel (virtual carrier sense). For example, the communication apparatus 100 stores the time period indicated by the Duration field included in the received signal in the communication apparatus 100 as a Network Allocation Vector (NAV). The communication apparatus 100 may treat the stored NAV as a time period in which the communication apparatus 100 does not transmit signals. In the present embodiment, the operation of setting the time period in which the communication apparatus 100 does not transmit based on information such as the Duration field of the received signal by the communication apparatus 100 may be referred to as setting the NAV. In other words, in the time period up until the NAV set for the channel expires, the communication apparatus 100 determines that a signal exists on the channel. In this manner, the communication apparatus 100 determines whether or not a signal is on the channel based on the result of executing a physical carrier sense and a virtual carrier sense. In a case where the communication apparatus 100 determines that a signal exists on the channel, unavailable for transmission may be determined. The state/status of the channel in this case may be referred to as a busy state. On the other hand, a state/status in which a signal is not detected on a channel in carrier sense and the NAV is not set may be referred to as an idle state. The communication apparatus 100 may determine that it is available for transmission in a case where the channel is in an idle state.

When the communication apparatus 100 transmits using a link with a bandwidth of 160 MHz for example, the communication apparatus 100 may determine whether or not transmission can be performed using only the primary channel (PCH) with a bandwidth of 20 MHz included in the link. For example, it is described in the IEEE 802.11 standard series that, in a case where the communication apparatus 100 determines that it is available for transmission as a result of performing carrier sense on the PCH over a predetermined time period, transmission can be started. The predetermined time period is determined by an Interframe Space (IFS) set per access category used to categorize the types of communication traffic and a random number (backoff counter) randomly set from a predetermined range. In other words, in a case where the communication apparatus 100 determines that the PCH is in an idle state throughout the predetermined time period, the communication apparatus 100 obtains the transmission right for transmitting using the link. At this time, in a case where a channel other than the PCH has been in an idle state during a PIFS period preceding the transmission start, the communication apparatus 100 may use the channel and the PCH in the idle state to perform transmission via channel bonding. PIFS is an abbreviation for Priority Interframe Space. Also, in a case where the communication apparatus 100 determines that it is unavailable for transmission as a result of performing carrier sense on the PCH, even if the other channels included in the same link are in the idle state, transmission may be deferred. Note that each of the channels other than the PCH that form one link may be referred to as a secondary channel (SCH). The secondary channels may be referred to as non-primary channels (NPCH).

In the communication apparatus 100, in a case where a signal is received in a certain channel and a signal is transmitted on another channel (for example, an adjacent channel or the like) placed at a frequency near that of the certain channel, the signal being received may not be appropriately received. Consider an example where the communication apparatus 100 can simultaneously execute transmission processing and receiving processing using different channels. In a case where the communication apparatus 100 is receiving using a certain channel and then performs transmission using an adjacent channel, interference may be caused in the reception signal due to the power of the transmission signal leaking to the channel of the reception signal. Typically, such power from the transmission signal leak is much greater than the received power of the reception signal, and thus the reception signal is not appropriately received. To avoid such a situation, the IEEE 802.11 standard series is provided with a mechanism that, while the communication apparatus is transmitting a signal, ensures that there is no transmission of a signal using a channel adjacent to the PCH by another communication apparatus to the communication apparatus. In other words, it is specified that a PCH is provided as a channel used commonly to determine whether transmission between communication apparatuses can be performed and, while one communication apparatus is performing transmission using the PCH, and the other communication apparatus does not perform transmission even if the other channels are in the idle state. Accordingly, while the communication apparatus is transmitting a signal and the PCH is being used, since another communication apparatus cannot transmit a signal using a channel adjacent to the PCH, a situation in which the communication apparatus receives a signal on the adjacent channel does not occur. Accordingly, the problem of interference caused by power leakage across channels as described above can be resolved.

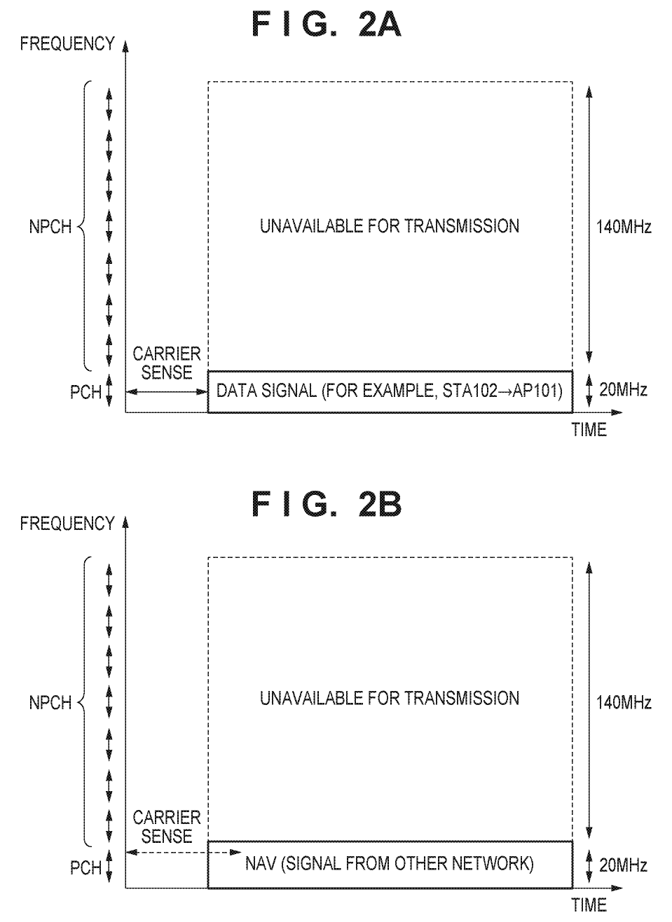

However, not using other channels (NPCH) in the idle state based on the PCH being in the busy state may hinder efficient use of the frequency resources of the entire link. FIG. 2A illustrates an example of a time chart in a case where the STA 102 transmits data to the AP 101. In FIG. 2A, after the STA 102 executes carrier sense for the PCH and confirms that the PCH is in the idle state, the STA 102 transmits data using the PCH with a 20 MHz bandwidth. In this case, for example, even if seven NPCHs other than the PCH are in the idle state, other communication apparatuses are not allowed to perform communication using the NPCHs. Also, FIG. 2B illustrates another example of a time chart in a case where the STA 102 transmits data to the AP 101. In FIG. 2B, while the STA 102 is executing carrier sense for the PCH, the PCH is being used by another network (for example, the network 11 in FIG. 1) that exists geographically near the STA 102. In this case, since it is determined that the PCH is in the busy state via carrier sense by the STA 102, for example, even if seven NPCHs other than the PCH are in the idle state, the STA 102 is not allowed to perform communication with the AP 101 using the NPCHs. However, at this time, since the AP 101 is not performing transmission, if the STA 102 performed transmission to the AP 101 using an NPCH, the AP 101 may appropriately receive a signal transmitted by the STA 102. In this manner, for example, by PCH with a bandwidth of 20 MHz being used by another network, unless the NPCH in the idle state accounting for the remaining 140 MHz is used, the frequency resources cannot be used efficiently.

In light of these circumstances, in the present embodiment, a function is provided for, in a case where the PCH is being used by another communication apparatus, performing communication between communication apparatuses using an NPCH included in the same link as the PCH instead of using the PCH. For example, in a case where the PCH is in the busy state, the communication apparatus 100 sets a Secondary Primary Channel (SPCH) to use to obtain a transmission right for communicating using the NPCH. The SPCH is one or more channels from among the NPCHs included in the same link as the PCH. In a case where the communication apparatus 100 determines that the PCH is being used by another communication apparatus, the communication apparatus 100 then determines whether or not transmission can be performed using the SPCH. In a case where the communication apparatus 100 determines that it is available for transmission using the SPCH, the communication apparatus 100 performs transmission using one or more NPCHs including the SPCH. In the present embodiment, the communication method for performing transmission using one or more channels including the SPCH instead of using the PCH is referred to as NPCH access (Non-Primary Channel Access, NPCA). Note that this communication method may be referred to by a different name. For example, this communication method may be referred to as Secondary Channel Access (SCA).

In the present embodiment, the communication apparatus 100 performs communication using a first communication method using one or more channels including the PCH and a second communication method (NPCH access) using one or more NPCHs not including the PCH. For example, the communication apparatus 100 has the function of executing both the first communication method and the second communication method and may perform communication using the first communication method in a case where the PCH can be used and may perform communication using the second communication method in a case where the PCH cannot be used. The PCH not being able to be used refers to a case where a NAV is set in the communication apparatus 100 due to another communication apparatus having started communication using the PCH, for example. Here, NPCH access may be set to end within the NAV time period set for the PCH. Also, NPCH access may be allowed only in a case where it ends within the NAV time period set for the PCH. When the PCH changes from the busy state to the idle state and the NPCH is in the busy state, there are cases where the next communication is performed using only the PCH and not the NPCH. Also, there are cases where the PCH is in the busy state at the time when the NPCH changes from the busy state to the idle state. In this manner, when the PCH and the NPCH are independently used, the frequency resources may not be used efficiently. To avoid such a situation, the communication apparatus 100 may control NPCH access in a manner such that NPCH access is completed within the NAV time period set for the PCH. On the other hand, there are cases where the NAV set for the PCH ends before the NPCH access is completed even in a case where control is performed in a manner such that NPCH access is completed within the NAV time period set for the PCH. For example, the NAV set in the communication apparatus 100 may be terminated (canceled) by a Contention Free- (CF-)END frame or the like. By the NAV set for the PCH being canceled, the communication apparatus 100 becomes able to use the PCH. Accordingly, for example, when the AP 101 and the STA 102 are communicating via NPCH access, the STA 103 may transmit to the AP 101 using the PCH. On the other hand, while NPCH access is being executed, if the AP 101 has not performed a reception operation using PCH, there is a possibility that the AP 101 will not receive the signal transmitted by the STA 103. Also, as described above, if the PCH and the NPCH each become independently used, there is a possibility that the frequency resources will not be used efficiently. According to the present embodiment, provided is technology for, in a case where NPCH access is being executed between the AP and the STA and the NAV set for the PCH has ended earlier than the initial setting, performing control for the communication apparatus 100 to communicate using the PCH.

### Apparatus Configuration

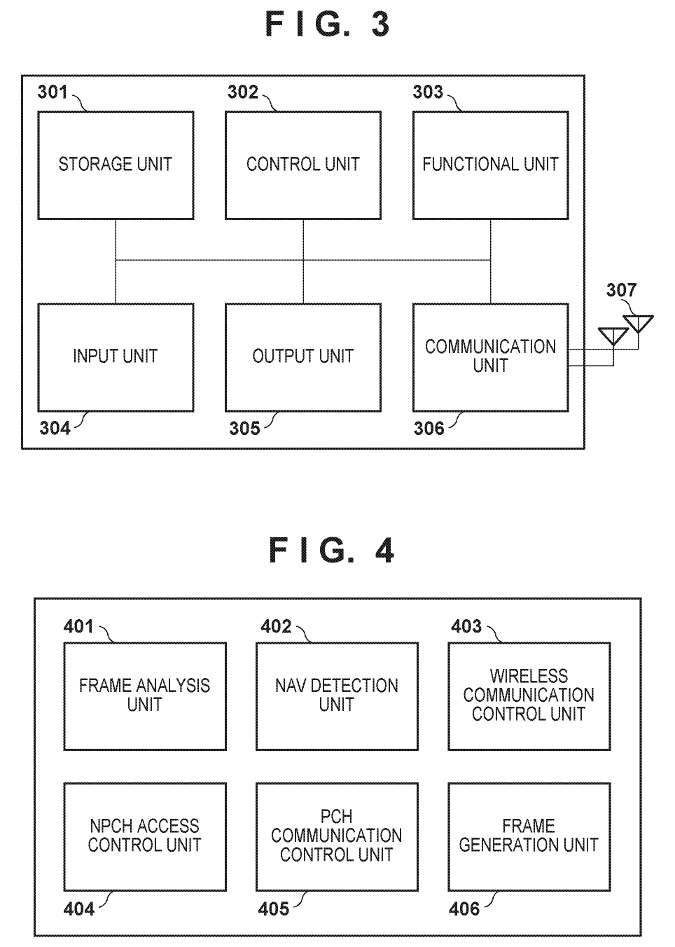

FIG. 3 illustrates a hardware configuration example of the communication apparatus 100 (AP and STA) according to the present embodiment. The communication apparatus 100, as an example of the hardware configuration, includes the storage unit 301, the control unit 302, a functional unit 303, an input unit 304, an output unit 305, a communication unit 306, and an antenna 307, for example. The communication apparatus 100 may include a plurality of antennas.

The storage unit 301 includes one or more memories including a ROM, a RAM, or the like and may store various types of information including control programs for the functional units constituting the communication apparatus 100 to perform various types of operations, parameters for communication, and the like. ROM is an abbreviation for Read Only Memory, and RAM is an abbreviation for Random Access Memory. The storage unit 301 may be configured to include, in addition to a memory such as a ROM and a RAM, a flexible disk, hard disk, an optical disk, a magneto-optical disk, a CD-ROM, a CD-R, magnetic tape, a non-volatile memory card, a DVD, or a similar storage medium.

The control unit 302, for example, includes one or more processors including a CPU, a MPU, or the like and controls the entire communication apparatus 100 by executing the control programs stored in the storage unit 301. Note that the control unit 302 may control the entire communication apparatus 100 via cooperation between the control programs stored on the storage unit 301 and an Operating System (OS). Note that CPU is an abbreviation for Central Processing Unit, and MPU is an abbreviation for Micro Processing Unit. In a case where the control unit 302 includes a plurality of processors that may be implemented by multiple cores or the like, the control unit 302 may be configured in a manner such that the entire communication apparatus 100 is controlled by the plurality of processors.

Also, the control unit 302 controls the functional unit 303 and executes predetermined processing, such as communication, image capture, printing, projecting, and the like. The functional unit 303 is hardware for the communication apparatus 100 to execute the predetermined processing described above. For example, in a case where the apparatus is a camera, the functional unit 303 is an image capture unit that executes image capture processing. Also, for example, in a case where the apparatus is a printer, the functional unit 303 is a printing unit that executes printing processing. In a case where the apparatus is a projector, the functional unit 303 is a projecting unit and executes projecting processing.

The input unit 304 receives various operations from a user. The output unit 305 outputs various types of output to a user via a monitor screen or a speaker, for example. In this example, output via the output unit 305 may correspond to displaying on a monitor screen, outputting audio via a speaker, outputting vibrations, and the like. Note that the input unit 304 and the output unit 305 may be implemented together as one module such as in the case of a touch panel. Also, the input unit 304 and the output unit 305 may each be an apparatus integrally formed with the communication apparatus 100 or may each be separate apparatuses.

The communication unit 306 performs control of wireless communication compliant with the IEEE 802.11bn standard. Also, the communication unit 306 may perform control of wireless communication compliant with another IEEE 802.11 standard series such as a legacy standard in addition to the IEEE 802.11bn standard. The communication unit 306 controls the antenna 307 and transmits and receives signals for wireless communication generated by the control unit 302. The communication unit 306 is a so-called radio chip, and this may be provided with one or more processors and memories. Note that in a case where the communication apparatus 100 supports NFC standards, Bluetooth standards, and similar wireless communication standards and wired LAN and similar wired communication in addition to the IEEE 802.11bn standard, the communication unit 306 may perform control of communication compliant with these communication standards. Also, in a case where the communication apparatus 100 can execute wireless communication that complies with a plurality of communication standards, the communication apparatus 100 may have a configuration in which a communication unit that supports each of the communication standards and an antenna are provided separately. The communication apparatus 100 communicates data with the partner communication apparatus via the communication unit 306. Note that the antenna 307 may be separately formed from the communication unit 306 or may be formed as a single module together with the communication unit 306. The communication apparatus 100 may separately be provided with the communication unit 306 for communicating using PCH and the communication unit 306 for NPCH access. Also, the communication apparatus 100 may separately be provided with the communication unit 306 corresponding to a master used for communication with other communication apparatuses and the communication unit 306 corresponding to a slave used for determining whether or not the PCH is in an available-for-use state while NPCH access is being executed. For example, the communication unit 306 corresponding to a slave may be a simple circuit provided with only the functions necessary for determining whether or not the PCH is in an available-for-use state. In a case where the communication apparatus 100 includes a plurality of the communication units 306, a portion of the communication units 306 may be configured to be used in NPCH access and the other communication units 306 may be configured to perform communication using the PCH. In this case, while NPCH access is not being executed, all of the communication units 306 may be used to perform communication using the PCH. The communication apparatus 100 may use the plurality of communication units 306 while switching the roles and uses. For example, the communication unit 306 used for communication using the PCH in a first time period may be used for communication using NPCH access in a second time period. Note that the AP 101 may include a circuit that simultaneously receives and processes signals received on each channel, the PCH and the NPCH.

The antenna 307, for example, is an antenna that can communicate at the 2.4 GHz band, the 5 GHz band, the 6 GHz band, millimeter waves, and the like. In FIG. 3, the illustrated configuration of the communication apparatus 100 includes the two antennas 307, but the communication apparatus 100 may include one or three or more antennas or may include one or more antennas for each frequency band usable by the apparatus. Also, in a case where the communication apparatus 100 includes a plurality of antennas, the communication apparatus 100 may include the communication unit 306 for each antenna.

### Functional Configuration

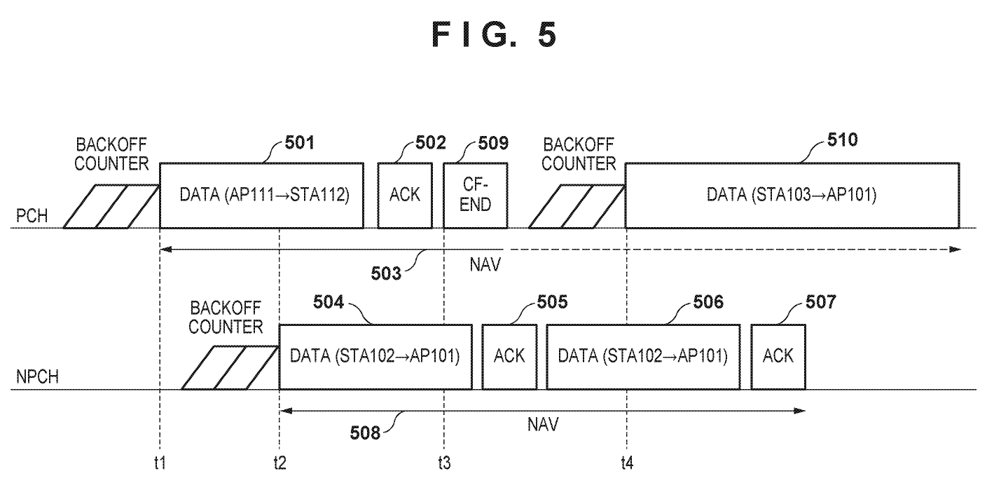

FIG. 4 illustrates an example of the functional configuration of the communication apparatus 100. The functional configuration according to the present embodiment, for example, is an example of a functional configuration implemented by the one or more processors executing programs stored in the one or more memories. The communication apparatus 100 includes a frame analysis unit 401, a NAV detection unit 402, a wireless communication control unit 403, an NPCH access control unit 404, a PCH communication control unit 405, and a frame generation unit 406. However, this is an example, and dedicated hardware for implementing each function may be prepared. Note that the configuration illustrated in FIG. 4 is an example, and the AP may include a configuration other than these configurations. Also, two or more of the functional blocks in FIG. 4 may be implemented as a single functional block, and one functional block may be divided into two or more functional blocks.

The frame analysis unit 401 performs analysis of the signal (frame) received by the communication unit 306 via the antenna 307. For example, when the frame analysis unit 401 receives a frame on a channel, the frame analysis unit 401 extracts the Duration field included in the frame and notifies the NAV detection unit 402 of the extracted Duration field. Also, in a case where the frame analysis unit 401 receives a frame with itself as the destination, the frame analysis unit 401 extracts the data included in the frame and hands the extracted data to a higher level layer. In a case where the frame analysis unit 401 receives a frame for canceling the NAV set for the PCH, the frame analysis unit 401 notifies the NAV detection unit 402 of this. In the present embodiment, a signal for canceling the NAV set for the channel is referred to as a completion signal. In a case where the frame analysis unit 401 receives a frame for notifying that the PCH has become available for use while the communication apparatus 100 is executing NPCH access, the frame analysis unit 401 notifies the NPCH access control unit 404 of this. In a case where the frame analysis unit 401 receives a frame for instructing the end of NPCH access while the communication apparatus 100 is executing NPCH access, the frame analysis unit 401 notifies the NPCH access control unit 404 of this. The frame for notifying that the PCH has become available for use and the frame for instructing the end of NPCH access may be received via a different link from the link being used to execute NPCH access. Also, the notification that the PCH has become available for use and the instruction for ending NPCH access may be included in a response to the frame transmitted via NPCH access.

The NAV detection unit 402 sets and updates the NAV for the PCH or the SPCH based on the Duration notified by the frame analysis unit 401 or a notification to cancel the set NAV. For example, in a case where the NAV detection unit 402 obtains Duration information from the frame analysis unit 401, the NAV detection unit 402 sets the NAV for the target channel. On the other hand, in a case where the NAV detection unit 402 receives a notification to cancel the NAV from the frame analysis unit 401, the NAV detection unit 402 resets (sets to zero) the NAV set for the target channel. Also, in a case where a NAV is set for the PCH, the NAV detection unit 402 determines whether or not the PCH has become available for use. In a case where the PCH has become available for use, the NAV detection unit 402 notifies the PCH communication control unit 405. The NAV detection unit 402 may determine that the PCH has become available for use based on receiving a completion signal on the PCH from the frame analysis unit 401.

The wireless communication control unit 403 executes transmission processing of each frame generated by the frame generation unit 406. Also, the wireless communication control unit 403 notifies the frame analysis unit 401 of the frame received via the antenna 307. For example, the wireless communication control unit 403 may execute transmission or reception of a data frame using either the first communication method or the second communication method. For example, the wireless communication control unit 403 executes carrier sense of the PCH when transmitting a data frame. In a case where a signal has been detected on the PCH or a NAV has been set in the NAV detection unit 402, the wireless communication control unit 403 may execute carrier sense of the SPCH. In a case where a signal has not been detected on the SPCH and a NAV has not been set for the SPCH by the NAV detection unit 402, for example, the wireless communication control unit 403 transmits a data frame using one or more NPCHs including the SPCH. In a case where the communication apparatus 100 includes a plurality of the communication units 306, the wireless communication control unit 403 performs communication using each communication unit 306. Also, in a case where a Multi-Link is established between the communication apparatus 100 and another communication apparatus, the wireless communication control unit 403 performs communication using each link.

The NPCH access control unit 404 executes setting and control for performing NPCH access. For example, in a case where the NPCH access control unit 404 is notified that the PCH has become available for use from the frame analysis unit 401 while the communication apparatus 100 is executing NPCH access, the NPCH access control unit 404 determines whether or not to end NPCH access. In a case where it is determined to end NPCH access, the NPCH access control unit 404 instructs the frame generation unit 406 to generate a signal for canceling the NAV set for the NPCH. Also, in a case where the NPCH access control unit 404 receives an instruction to end NPCH access from the frame analysis unit 401, the NPCH access control unit 404, following this instruction, instructs the frame generation unit 406 to generate a completion signal for canceling the NAV set for the NPCH.

In a case where the PCH communication control unit 405 is notified that the PCH has become available for use from the NAV detection unit 402, the PCH communication control unit 405 executes control for communicating using the PCH. Control for communicating using the PCH executed by the PCH communication control unit 405 will be described below in detail. The PCH communication control unit 405 may control each functional unit including the wireless communication control unit 403 in order to perform communication using the PCH. The frame generation unit 406 generates a frame for when the communication apparatus 100 performs communication with a partner communication apparatus. The frame generation unit 406, for example, generates a frame including each of a reserve signal for reserving a channel, a notification that the PCH has become available for use, a completion signal for canceling the NAV set for a channel, and the like and notifies the wireless communication control unit 403.

### Example of Processing executed in Communication Apparatus

Examples of the flow of processing executed by the communication apparatus 100 according to the present embodiment will be described below. In the present processing example described herein, in a case where an NAV is set for the PCH, the AP 101 receives a signal transmitted from the STA 102 via NPCH access. Note that the following processing examples are described as operations of the AP 101, but these are also applicable to operations of the STA 102.

### Processing Example 1

FIG. 5 illustrates an example of a time chart relating to signals exchanged on each of the PCH and the NPCH in the present processing example. First, at time t1, the AP 111 associated with OBSS has transmitted a data frame 501 with the STA 112 as the destination using the PCH. The AP 101 and the STA 102 set a NAV 503 for the PCH based on the Duration field value or the like included in the received data frame 501. In a case where the data frame 501 is successfully received, the STA 112 transmits an ACK 502. On the other hand, in the STA 102, when data with AP 101 as the destination accumulates in the transmission buffer, the STA 102 starts a channel access process for transmitting the data. In other words, the STA 102 performs carrier sense for the PCH and starts transmission of the data if the PCH is confirmed to be in the idle state. Here, since the NAV 503 is set for the PCH, the STA 102 executes carrier sense of the SPCH according to the NPCH access process. At time t2, the STA 102 starts transmission of a data frame 504 with the AP 101 as the destination based on the SPCH being in the idle state for a certain time period including a backoff counter. At this time, the STA 102 may perform transmission using one or more NPCHs including the SPCH in the idle state. Also, the STA 102 may obtain a Transmission Opportunity (TXOP) for a channel to use in transmission when transmitting the data frame 504. The TXOP is a time period in which the communication apparatus that obtained that transmission right for a channel has exclusivity of the channel based on the transmission right. For example, the STA 102 may obtain, as the TXOP, a time period including a required time for transmitting two data frames 504 and 506 to the AP 101 and the required time for receiving ACK 505 and 507, which are acknowledgements of each piece of data, from the AP 101. The TXOP may be indicated in the Duration field included in the header of the data frame 504 or may be indicated via exchanging an RTS frame and a CTS frame (RTS/CTS exchange, not illustrated). In this case, information indicating the TXOP may be stored in the Duration field of each of the RTS frame and the CTS frame transmitted before the data frame 504. Note that RTS is an abbreviation for Request To Send, and CTS is an abbreviation for Clear To Send. The communication apparatus 100 that receives the data frame 504 and the like sets a NAV 508 of a time period in accordance with the TXOP. Accordingly, the communication apparatus that obtains the channel transmission right may have exclusivity of the channel during this TXOP time period. Note that the STA 102 may set a time period shorter than the time period up until the NAV 503 set for the PCH expires as the TXOP time period. Accordingly, if the NPCH is available for use at the time that the NAV 503 for the PCH expires, at the next transmission opportunity, channel bonding using the PCH and the NPCH can be executed. Note that in the example described here, the STA 102 obtains the TXOP for the NPCH. However, no such limitation is intended. In a case where the AP 101 includes data to be transmitted, the AP 101 can also attempt to obtain a TXOP for the NPCH. In a case where the AP 101 gains channel access for the NPCH, the AP 101 may perform data transmission addressed to the STA using the NPCH. Returning to the description of FIG. 5, at time t3, a CF-END frame 509 is transmitted using the PCH as a completion signal for canceling the NAV 503 set for the PCH. The CF-END frame 509 may be transmitted by the AP 111. Accordingly, a new signal may be transmitted using the PCH based on the PCH becoming available for use. In the example of FIG. 5, at time t4, the STA 103 starts transmission of a data frame 510 with the AP 101 as the destination using the PCH. For example, in a case where the STA 103 is a communication apparatus that performs communication using only the PCH, the STA 103 may transmit the data frame 510 to the AP 101 using the PCH in the idle state regardless of whether or not the AP 101 is performing communication via NPCH access.

In the present processing example, in a case where the PCH has become available for use while the AP 101 is receiving the data frame 504 via the NPCH, the AP 101 performs an operation for receiving a signal transmitted using the PCH. For example, first, the AP 101 performs monitoring to determine whether or not the PCH has become available for use in parallel with communication via NPCH access. For example, the AP 101 may determine that the PCH has become available for use by detecting a completion signal on the PCH. When the AP 101 determines that the PCH has become available for use, the AP 101 starts a PCH reception operation in preparation for receiving a signal that may be transmitted using the PCH. Then, in a case where the AP 101 detects a new signal on the PCH, the AP 101 starts reception processing for this signal. In a case where the signal received via the PCH is a signal having the AP 101 as the destination (for example, the data frame 510), the AP 101 may execute reception processing for this signal and transfer the obtained data to a higher level layer. Also, in a case where the signal received via the PCH is not a signal having the AP 101 as the destination, the AP 101 may cancel the reception processing and discard the received signal. In this manner, by performing a PCH reception operation based on detecting that the PCH has become available for use while communicating via NPCH access, the AP 101 can successfully receive a signal transmitted using the PCH.

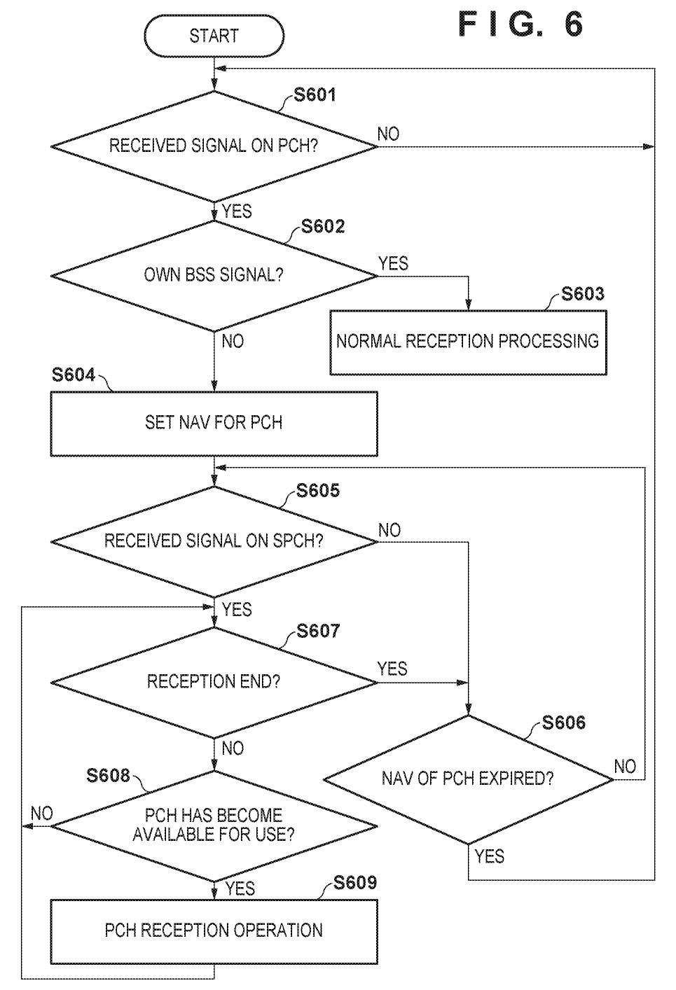

FIG. 6 illustrates an example of the flow of the reception operation executed by the AP 101 in the time chart of FIG. 5. The reception operation is applicable to the communication apparatus 100 including the STA 102 and not only the AP 101. Thus, the reception operation will be described below as an operation of the communication apparatus 100. First, the communication apparatus 100 performs detection of a signal on the PCH. In a case where a signal is received via the PCH (YES in S601), the communication apparatus 100 determines whether or not it is its own BSS signal (S602). For example, the communication apparatus 100 may determine whether the signal is its own BSS signal or an OBSS signal based on whether or not the BSS Color field included in the received signal matches the BSS Color of its own BSS. Also, the communication apparatus 100 may determine whether the signal is its own BSS signal or an OBSS signal based on whether or not a value stored in a destination field, a source field, or the like included in the received signal matches a parameter of its own BSS. In a case where the received signal is its own BSS signal, the communication apparatus 100 executes normal reception processing (S603). Normal reception processing, for example, is an apparatus extracting data or the like from a signal and transferring the data to a higher level layer or the like if the apparatus itself is the destination of the signal based on the destination field of the received signal. Also, if the apparatus itself is not the destination of the signal, the signal is discarded. On the other hand, in a case where the received signal is not its own BSS signal (NO in S602), the communication apparatus 100 sets a NAV for the PCH based on the value of the Duration field included in the received signal (S604). Next, the communication apparatus 100 performs detection of a signal on the SPCH. In a case where the NAV set for the PCH expires before a signal is detected on the SPCH (NO in S605 and YES in S606), the communication apparatus 100 returns to S601 and continues the processing.

On the other hand, in a case where a signal transmitted using one or more NPCHs including the SPCH is detected on the SPCH (YES in S605), the communication apparatus 100 executes reception processing for this signal. Also, the communication apparatus 100 performs monitoring of the PCH in parallel with execution of the reception processing. Here, in a case where the PCH has become available for use before the reception processing is complete (YES in S608), the communication apparatus 100 performs control for communicating using the PCH (S609). Control for communicating using the PCH may be, for example, a reception operation for a new signal on the PCH or signal detection for receiving a new signal. In a case where a new signal is received on the PCH, the communication apparatus 100 may execute reception processing for the received signal in a similar manner to the processing of S601 to S604. Note that, in regards to the functions provided for communication using the PCH, in the time period in which the NAV is set for the PCH, the communication apparatus 100 may cause only the minimum number of functions required for PCH monitoring to operate and cause the other functions to perform a power save operation. Also, when the communication apparatus 100 detects that the PCH has become available for use, these functions may transition from the power save operation to a normal reception operation. By performing power save operations during the NAV time period, the amount of power consumed can be reduced. Note that in a case where the signal received in S605 is not an OBSS signal or a self-addressed signal, the communication apparatus 100 may set a NAV based on the value of the Duration field included in the signal for the SPCH and wait for reception processing until the NAV expires. In a case where the signal reception processing via NPCH access is completed (NO in S608 and YES in S607), the communication apparatus 100 continues carrier sense of the SPCH until the NAV set for the PCH expires (S606). When the NAV of the PCH expires, the communication apparatus 100 returns to S601 and continues the processing. Note that though not illustrated in FIG. 6, as described above, the communication apparatus 100 can also attempt to obtain a TXOP for the NPCH at a time after a NAV has been set for the PCH. In a case where the communication apparatus 100 gains a TXOP for the NPCH, instead of the processing of S605 to S606, data transmission processing using the NPCH may be executed. Also at this time, the communication apparatus 100 executes monitoring of the PCH in parallel with execution of the transmission processing.

As described in the example described above, in a case where the PCH has become available for use, PCH reception processing is executed as control for communicating using the PCH by the communication apparatus 100. However, the control for communicating using the PCH by the communication apparatus 100 is not limited thereto. For example, the communication apparatus 100 may execute PCH transmission processing. For example, at time t4 of FIG. 5, the AP 101 may transmit a signal having the STA 103 as the destination using the PCH. At this time, there is a possibility that the transmission power of the PCH causes interference with the NPCH. On the other hand, in a case where there are a plurality of NPCHs, the NPCH used by the AP 101 to receive data frames from the STA 102 and the PCH may be separated on the frequency axis. For example, in a case where the NPCH receiving a signal from the STA 102 and the PCH are separated on the frequency axis and the interference power caused in the NPCH by transmission using the PCH is less than a threshold, the AP 101 may determine to execute transmission using the PCH.

Also, in the example of FIG. 5, the AP 101 receives a signal via the PCH and the NPCH. However, in a case where the AP 101 transmits a signal having the STA 102 as the destination via NPCH access, the AP 101 may transmit a signal having the STA 103 as the destination at time t4. At this time, the AP 101 may adjust the length of the data frame and the transmission period to avoid an overlap on the time axis between a downstream signal transmitted with the STA 102 or the STA 103 as the destination and an upstream signal received from the STA 102 or the STA 103. For example, to avoid an overlap on the time axis between a signal transmitted to the STA 102 and an ACK received from the STA 103, the AP 101 may perform adjustment and insert padding or the like into the signal transmitted to the STA 103 so that the signals transmitted to each STA simultaneously complete transmission. By the AP 101 performing adjustment to align the end time of each of the communication using the PCH and the NPCH access, mutual interference between these communication can be avoided and, at the next transmission opportunity, channel bonding using the PCH and the NPCH can be used.

As described above, in the present processing example, the communication apparatus 100 performing communication via NPCH access determines in parallel whether or not the PCH has become available for use and in a case where the PCH has become available for use during communications via NPCH access, the communication apparatus 100 performs control for communicating using the PCH. For example, as control for communicating using the PCH, a new signal having itself, the communication apparatus 100, as the destination can be received via the PCH by starting a PCH reception operation. Also, in a case where the communication apparatus 100 is transmitting via NPCH access, as control for communicating using the PCH, transmission using the PCH may be performed in order to avoid a signal having the communication apparatus 100 as the destination being transmitted using the PCH. Also, by the communication apparatus 100 adjusting the end time of the communication using the PCH and the communication using the NPCH access, at the next transmission opportunity, channel bonding using both the PCH and the NPCH can be executed.

### Processing Example 2

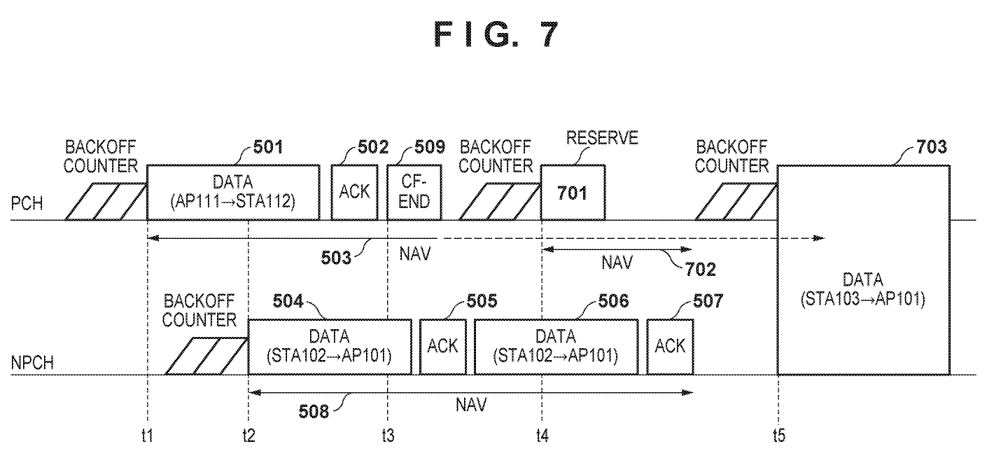

As an operation of the AP 101 according to processing example 1 described above, in a case where it is determined that the PCH has become available for use, the AP 101 performing communication via NPCH access receives or transmits data using the PCH. As an operation of the AP 101 according to the present processing example, in a case where it is determined that the PCH has become available for use, the AP 101 performing communication via NPCH access transmits a signal for preventing other communication apparatuses from transmitting using the PCH. FIG. 7 illustrates an example of a time chart relating to signals exchanged in each of the PCH and the NPCH in the present processing example. Operations similar to those of FIG. 5 are given the same reference number and description will be omitted. First, at time t1, the AP 111 transmits the data frame 501 with the STA 112 as the destination using the PCH, and the AP 101 and the STA 102 that receive this set the NAV 503 for the PCH. At time t2, the STA 102 uses NPCH access to start transmission of the data frame 504 with the AP 101 as the destination. At time t3, the CF-END frame 509 for canceling the NAV 503 set for the PCH is transmitted. Accordingly, there is a possibility that a new signal having the AP 101 as the destination is transmitted using the PCH based on the PCH becoming available for use. When the AP 101 determines that the PCH has become available for use, at time t4, the AP 101 transmits a signal for preventing transmission using the PCH. Accordingly, the AP 101 may avoid a signal having itself as the destination being transmitted using the PCH. For example, the AP 101 transmits a reserve signal 701 for reserving a channel on the PCH in order to prevent transmission using the PCH. For example, the signal for reserving a channel may be a CTS-to-Self frame. As with the RTS/CTS exchange, a CTS-to-Self frame is used as a frame for protecting subsequent signals from interference. In the present processing example, the CTS-to-Self frame may be used for prohibiting other communication apparatuses from transmitting using the PCH. Also, compared to the RTS/CTS exchange, when a CTS-to-Self frame is used, reception processing in the AP 101 is not required as channel reserving is completed with transmission of a single frame. The communication apparatus 100 (the STA 103, the AP 111, the STA 112, or the like) that receives the reserve signal including the channel reserve period sets a NAV 702 for the PCH. When the NAV 702 expires, each communication apparatus 100 determines that the PCH has become available for use and starts a channel access process. For example, at time t5, the STA 103 obtains a transmission right, and a data frame 703 with the AP 101 as the destination is transmitted via channel bonding using the PCH and the NPCH.

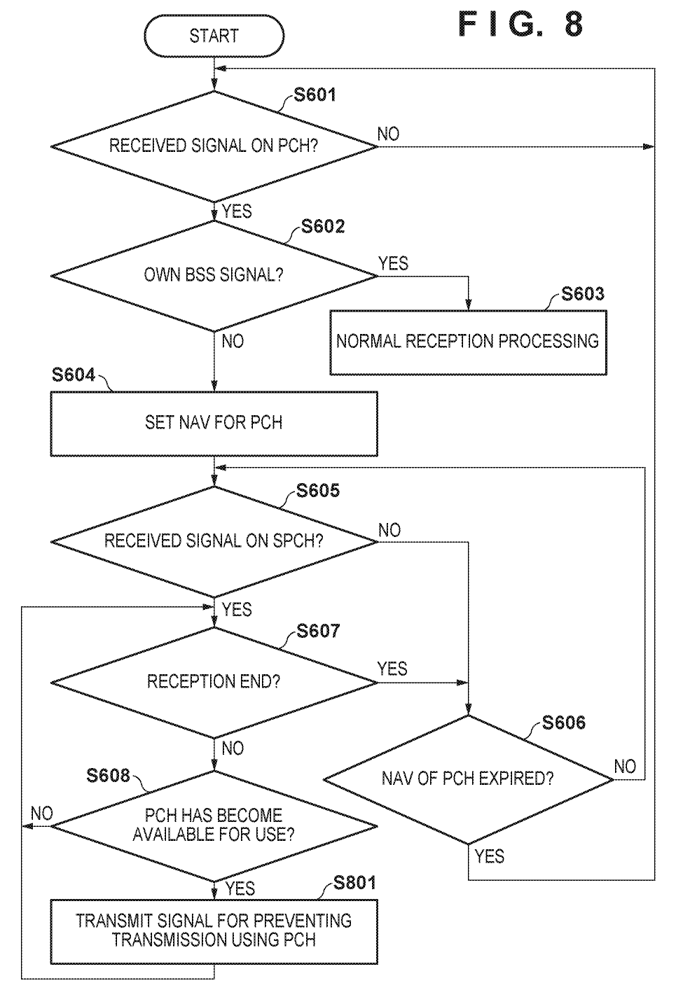

FIG. 8 illustrates an operation flow executed by the AP 101 in the time chart of FIG. 7. As with FIG. 6, this is applicable to the communication apparatus 100 including the STA 102. Thus, the operation will be described below as an operation of the communication apparatus 100. Also, operations similar to those of FIG. 6 are given the same reference number and description will be omitted. First, the communication apparatus 100 executes carrier sense of the PCH according to the process of S601 to S604. In a case where a NAV is set for the PCH via an OBSS signal (NO in S602), the communication apparatus 100 then executes carrier sense of the SPCH. In a case where a signal is detected on the SPCH (YES in S605), the communication apparatus 100 executes reception processing for this signal. Also, the communication apparatus 100 performs monitoring of the PCH in parallel with execution of the reception processing. In a case where the NAV set for the PCH has ended before the reception processing is completed (YES in S608), the communication apparatus 100 transmits a signal for preventing transmission using the PCH (S801). The communication apparatus 100 may determine the time period for preventing transmission using the PCH based on the TXOP time period for NPCH access and may prevent transmission using the PCH during this time period. For example, the communication apparatus 100 may set the value of the Duration field included in the CTS-to-Self frame in a manner such that the end of the time period for preventing transmission using the PCH aligns with the expiration of the TXOP time period for NPCH access. By aligning the end of the time period for preventing transmission using the PCH and the expiration of the TXOP time period for NPCH access, at the next transmission opportunity, there is an increased possibility that channel bonding using both the PCH and the NPCH can be performed. Note that the communication apparatus 100 may set the time period for preventing transmission using the PCH to longer than the expiration of the TXOP time period for NPCH access taking into account the amount of time required for switching from the AP 101, the STA 102, or the like communicating using NPCH access to communicating using the PCH. In a case where a certain time period is required for switching the communication method used in the communication, the communication apparatus 100 may guarantee fair channel access to the communication apparatus that executed NPCH access and other communication apparatuses. In this manner, the end of the time period for preventing transmission using

the PCH and the expiration of the TXOP time period for NPCH access do not need to be at the same time and may be a certain amount different within a range in which the channel bonding using both the PCH and the NPCH is not inhibited at the next transmission opportunity. In a case where the signal reception processing via NPCH access is completed (NO in S608, YES in S607), the communication apparatus 100 continues carrier sense of the SPCH until the NAV of the PCH expires (S606). When the NAV of the PCH expires, the communication apparatus 100 returns to S601 and continues the processing.

In the example described above, in a case where the PCH becomes available for use, the communication apparatus 100 transmits a CTS-to-Self frame using the PCH. However, the signal for preventing transmission using the PCH is not limited to a CTS-to-Self frame. The AP 101 may execute an RTS/CTS exchange using the PCH. For example, the AP 101 may execute an RTS/CTS exchange using the PCH with the STA 102 performing communication using the NPCH. Also, the AP 101 may execute an RTS/CTS exchange with another STA connected to the AP 101. Via an RTS/CTS exchange, compared to using a CTS-to-Self frame, transmission using the PCH can be prevented in a geographically larger area. Also, the AP 101 may determine whether or not to transmit a CTS-to-Self frame or the like based on interference in NPCH access caused by transmission power of the PCH. For example, in a case where the interference power caused in the NPCH when transmission is performed using the PCH is less than a threshold, the AP 101 may determine to transmit a CTS-to-Self frame or the like using the PCH. On the other hand, in a case where the interference power caused in the NPCH when transmission is performed using the PCH is greater than the threshold, the AP 101 may start an operation for receiving a new signal using the PCH without transmitting a CTS-to-Self frame. In this manner, even if transmission by another communication apparatus using the PCH cannot be prevented, the AP 101 can receive a signal having itself as the destination transmitted using the PCH. Note that in the example described using FIG. 7, the AP 101 receives the signal. However, in a case where the AP 101 is transmitting the signal to the STA 102 via NPCH access, the interference caused in the NPCH has little effect even if the AP 101 transmits a signal using the PCH during this transmission. Thus, in a case where the AP 101 determines that the PCH has become available for use while it is transmitting a signal via NPCH access, the AP 101 may transmit a CTS-to-Self frame using the PCH regardless of the magnitude of the interference between the NPCH and the PCH. In other words, the AP 101 determines whether it is transmitting using NPCH access or receiving and, based on this result, may transmit a CTS-to-Self frame using the PCH.

As described above, in the present processing example, the communication apparatus 100 performing communication via NPCH access determines in parallel whether or not the PCH has become available for use and in a case where the PCH has become available for use, the communication apparatus 100 prevents transmission of a signal by other communication apparatuses using the PCH. This can avoid a signal having the communication apparatus communicating via NPCH access as the destination being transmitted using the PCH, for example. Also, by aligning the end of the time period for preventing transmission using the PCH and the end of communication via NPCH access, at the next transmission opportunity, there is an increased possibility that channel bonding using both the PCH and the NPCH can be performed, allowing the frequency resources to be efficiently used.

### Processing Example 3

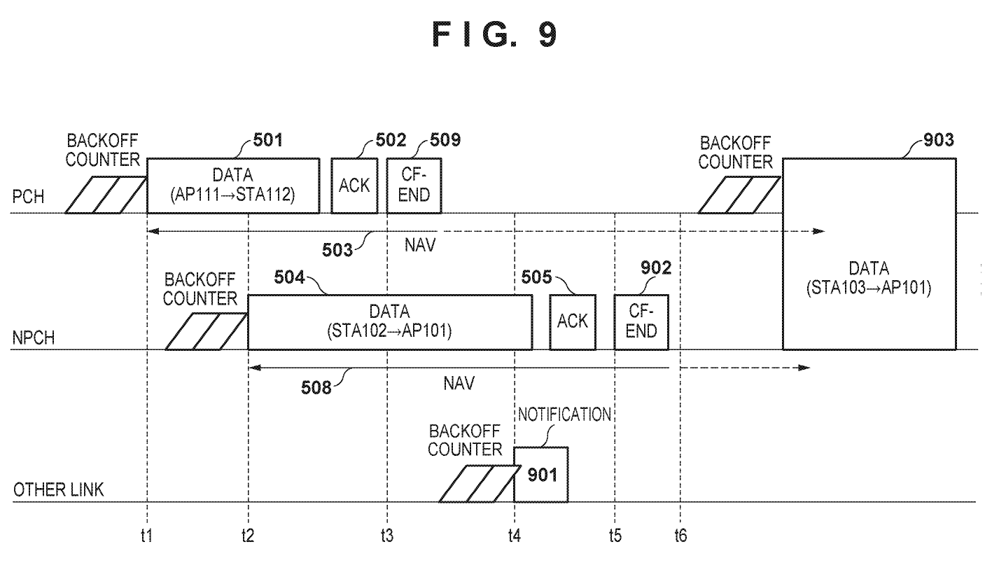

As an operation of the AP 101 according to the present processing example described here, in a case where it is determined that the PCH has become available for use, the AP 101 performing communication via NPCH access performs control to end NPCH access. FIG. 9 illustrates an example of a time chart relating to signals exchanged in each of the PCH, the NPCH, and another link in the present processing example. Operations similar to those of FIG. 5 are given the same reference number and description will be omitted. At time t3, the AP 101 determines that the PCH has become available for use due to receiving the CF-END frame 509 via the PCH. Then, at time t4, the AP 101 transmits a notification signal 901 indicating that the PCH has become available for use to the STA 102 performing transmission via NPCH access. For example, in a case where the AP 101 and the STA 102 have established Multi-Link and are communicating, the AP 101 may transmit the notification signal 901 using a different link to the link being used for communication via NPCH access. The STA 102 that receives the notification signal 901 does not execute transmission of the data frame (for example, the data frame 506 in FIGS. 5 and 7) scheduled for transmission and transmits a CF-END frame 902 for canceling the NAV 508 set for the NPCH. Accordingly, the NPCH also becomes available for use. For example, at time t6, in a case where data with the AP 101 as the destination is accumulated at a transmission buffer of the STA 103, the STA 103 executes carrier sense of the PCH and transmits a data frame 903 via channel bonding using the PCH and the NPCH.

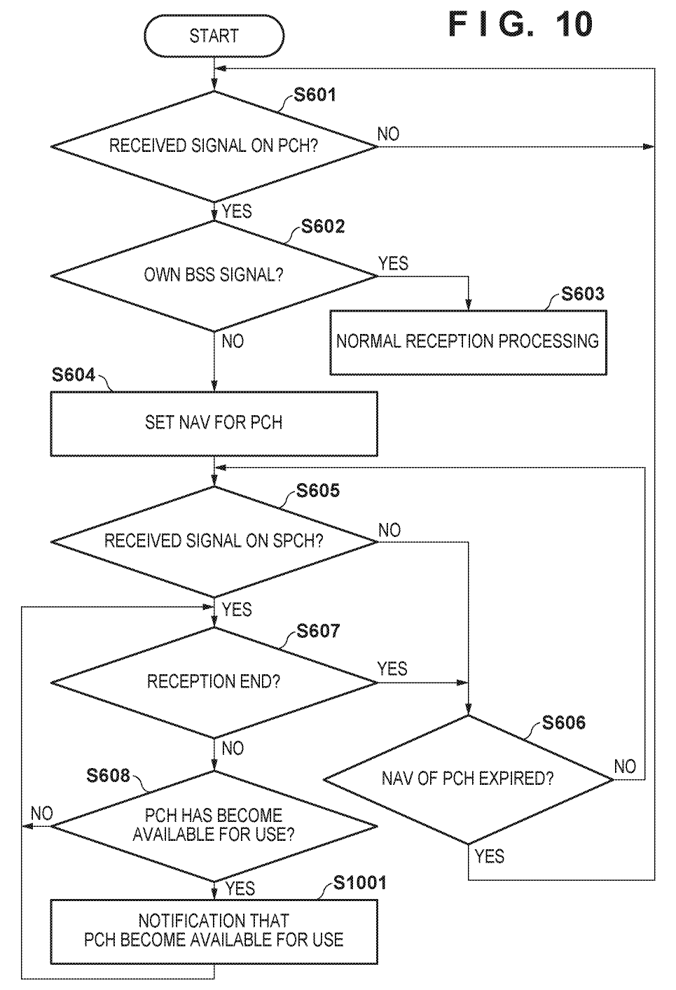

FIG. 10 illustrates an operation flow executed by the AP 101 in the time chart of FIG. 9. Operations similar to those of FIG. 6 are given the same reference number and description will be omitted. The following operations are described as operations of the AP 101, but the present operation flow is also applicable to the communication apparatus 100 including the STA 102. First, the AP 101 executes carrier sense of the PCH according to the process of S601 to S604. In a case where a NAV is set for the PCH via an OBSS signal (NO in S602), the AP 101 then executes carrier sense of the SPCH. In a case where a signal is detected on the SPCH (YES in S605), the AP 101 executes reception processing for this signal. Also, the AP 101 performs monitoring of the PCH in parallel with execution of the reception processing. In a case where the NAV set for the PCH has ended before the reception processing is completed (YES in S608), the AP 101 transmits a notification signal indicating that the PCH has become available for use (S1001). The AP 101 may transmit a signal instructing to end transmission using the NPCH instead of a notification signal indicating that the PCH has become available for use. In a case where the STA 102 receives a notification signal indicating that the PCH has become available for use, the STA 102 may determine whether or not to end NPCH access based on the type of data being transmitted via NPCH access or the like. For example, in a case where the data being transmitted is latency requirement data, the STA 102 may continue NPCH access unchanged. On the other hand, in a case where the STA 102 is instructed to end transmission using the NPCH, the STA 102 may end NPCH access according to the instruction. In a case where the signal reception processing via NPCH access is completed (NO in S608, YES in S607), the AP 101 continues carrier sense of the SPCH until the NAV of the PCH expires (S606). When the NAV of the PCH expires, the AP 101 returns to S601 and continues the processing.

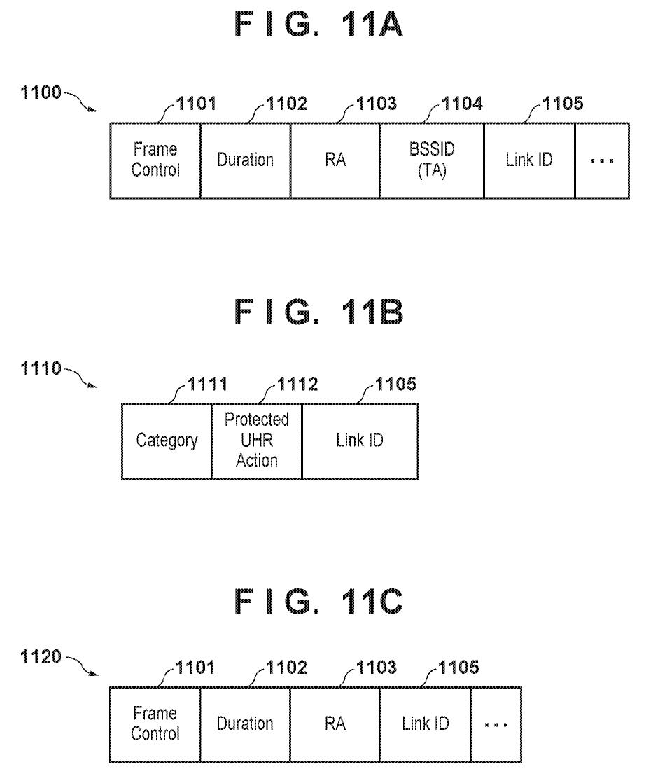

FIGS. 11A to 11C illustrate examples of a notification signal indicating that the PCH has become available for use for the communication apparatus 100. FIG. 11A illustrates an example of a notification signal in a case where the notification uses a control frame. A control frame 1100 of FIG. 11A may be referred to as an Extended CF-END frame. Note that the control frame 1100 may be referred to by a different name. The control frame 1100 is configured to include a Frame Control field 1101, a Duration field 1102, a RA field 1103, a BSSID field 1104, and a Link ID field 1105. Note that RA is an abbreviation for Receiver Address. The Frame Control field 1101 includes information relating to frame control. For example, the Frame Control field 1101 includes information such as the frame type and subtype. For example, in the case of an Extended CF-END frame, the frame type is Control and the subtype is Extended CF-END. The Duration field 1102 indicates the amount of time required to transmit the frame and an estimation value of the amount of time required for the response, frame interval, and the like, for example. The RA field 1103 indicates address information of the communication apparatus to receive the frame. For example, the RA field 1103 may store the address of a partner communication apparatus communicating via NPCH access using a different link with the communication apparatus 100 that transmits the frame. The BSSID field 1104 indicates the identifier of the BSS associated with the communication apparatus 100 that transmits the frame or the address of the communication apparatus 100 that transmits the frame. The Link ID field 1105 indicates information that can identify the link that transitioned from a PCH busy state to a PCH available for use state. Since that Frame Control field 1101 indicates that the control frame 1100 is an Extended CF-END frame, the communication apparatus 100 that receives the control frame 1100 learn that the PCH has become available for use for any one of the links. Also, via the Link ID field 1105, the communication apparatus 100 learns for which link the PCH has become available for use.

FIG. 11B illustrates an example of a notification signal in a case where the notification uses an Action frame including a predetermined Action field. An Action field 1110 of FIG. 11B may be referred to as a CF-END Notification Action field. Note that the Action field 1110 may be referred to by a different name. The Action field 1110 is configured to include a Category field 1111, a Protected UHR Action field 1112, and the Link ID field 1105. The Category field 1111 indicates the category of the Action field. For example, the Category field 1111 stores the identification number corresponding to the Protected UHR. The Protected UHR Action field 1112 indicates the identifier of the Action field in the category of the Protected UHR. For example, the Protected UHR Action field 1112 stores an identification number indicates the CF-END Notification Action field. As in FIG. 11A, the Link ID field 1105 indicates information that can identify the link that transitioned from a PCH busy state to a PCH available for use state. Since the Protected UHR Action field 1112 is a CF-END Notification Action field, the communication apparatus 100 learns that the PCH has become available for use for any one of the links. Also, via the Link ID field 1105, the communication apparatus 100 learns for which link the PCH has become available for use.

In a case where the link for which the PCH has become available for use matches the link used by the communication apparatus 100 to execute NPCH access, the communication apparatus 100 determines whether or not to end NPCH access. Note that the control frame 1100 or the Action field 1110 may be transmitted to instruct for the end of NPCH access using the link indicated by the Link ID 1105. In this case, the communication apparatus 100 that receives the control frame 1100 or the Action field 1110 ends NPCH access according to the instruction.

In the example described above, in a case where the PCH has become available for use, the AP 101 uses a different link to notify the STA 102. However, the method used by the AP 101 to notify or instruct the STA 102 is not limited thereto. For example, the AP 101 may notify or instruct the STA 102 using the ACK 505 corresponding to the data frame 504 received using the NPCH. Accordingly, such a notification and instruction can be executed even between communication apparatuses not performing Multi-Link communication. FIG. 11C illustrates another example of a notification signal in a case where the notification uses a control frame. A control frame 1120 of FIG. 11C may be referred to as an Extended ACK frame. Note that the control frame 1120 may be referred to by a different name. The control frame 1120 is configured to include the Frame Control field 1101, the Duration field 1102, the RA field 1103, and the Link ID field 1105. Configurations similar to those of FIG. 11A are given the same reference number and description will be omitted. The subtype included in the Frame Control field 1101 in the Extended ACK frame may be Extended ACK. Since that Frame Control field 1101 indicates that the control frame 1120 is an Extended ACK frame, the communication apparatus 100 that receives the control frame 1120 learn that the PCH has become available for use for any one of the links. Also, via the Link ID field 1105, the communication apparatus 100 learns for which link the PCH has become available for use.

In the example described using FIG. 9, the AP 101 receives a signal via NPCH access. However, in a case where the AP 101 is transmitting a signal to the STA 102 via NPCH access, the AP 101 may autonomously end NPCH access. For example, in a case where the AP 101 determines that the PCH has become available for use while performing NPCH access, the AP 101 may transmit a CF-END without transmitting a data frame scheduled to be transmitted thereafter. By the communication apparatus transmitting via NPCH access ending NPCH access depending on the PCH status, at the next opportunity, there is an increased possibility that channel bonding using both the PCH and the NPCH can be executed. Accordingly, the frequency resource can be efficiently used.

As described above, in the present processing example, the communication apparatus 100 performing communication via NPCH access determines in parallel whether or not the PCH has become available for use and in a case where the PCH has become available for use, the communication apparatus 100 executes control to end NPCH access. Accordingly, at the next transmission opportunity, there is an increased possibility that channel bonding using both the PCH and the NPCH can be executed, allowing the frequency resources to be efficiently used.

As described above, according to the present embodiment, communication using the NPCH can be executed based on carrier sense of the SPCH even in a case where the PCH cannot be used. Accordingly, the link frequencies can be efficiently used, and the communication capacity provided by the wireless communication system is increased. Also, according to the present embodiment, in a case where the PCH has become available for use while communication is being performed via NPCH access, control is executed to communicate using the PCH. In this manner, a signal transmitted using the PCH can be successfully received. Also, according to some embodiments, by controlling the timing of when the PCH and the NPCH become available for use, at the next transmission opportunity, there is an increased possibility of channel bonding using the PCH and the NPCH being executed. Accordingly, the frequency resource can be efficiently used.

The present technology may also be applied to a plurality of STAs. Also, in the present embodiment described above, the communication method that does not use the PCH is referred to as NPCH access. However, no such limitation is intended, and this communication method may be referred to as Secondary Primary channel access or the like, for example. In the present embodiment described above, a channel for determining whether transmission can be performed using the NPCH is referred to as SPCH for the sake of convenience. However, no such limitation is intended. As channel means a CH with a high priority for determining whether transmission can be performed from among the plurality of secondary channels, it may be referred to as PSCH (Primary Secondary Channel). In the case of using either term, channel means a channel to be used for determining whether transmission can be performed using the NPCH. Also, the names for the information elements and various types of fields according to the present embodiment may be referred to by different names. Note that the operations of the communication apparatus 100 in each processing example described above may be combined. For example, in a case where the interference power caused in the NPCH by transmission of a signal using the PCH is less than a threshold, the communication apparatus 100 that has determined that the PCH has become available for use may transmit a reserve signal for the PCH. On the other hand, in a case where the interference power caused in the NPCH by transmission of a signal using the PCH is greater than a threshold, the communication apparatus 100 that has determined that the PCH has become available for use may execute a reception operation for receiving a signal addressed to itself without transmitting a reserve signal for the PCH. Also, when it is determined that the PCH has become available for use, the communication apparatus 100 may transmit a reserve signal for the PCH while also instructing the partner communication apparatus to end NPCH access. In this case, in response to receiving the CF-END for canceling the NAV set for the NPCH, the communication apparatus 100 may transmit a CF-END for canceling the NAV from the reserve signal set for the PCH.

According to the present disclosure, frequency resources can be more efficiently used in a communication system using a communication link including a plurality of channels.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus that performs communication compliant with IEEE 802.11 standard series, comprising:
at least one memory that stores a set of instructions; and
at least one processor that executes the instructions, the instructions, when executed, causing the communication apparatus to perform operations comprising:
performing communication with another communication apparatus using a first channel access method that uses at least a Primary channel of one link and a second channel access method that, in a case where the Primary channel is in a busy state, uses a Non-Primary channel different from the Primary channel from among a plurality of channels included in the link and does not use the Primary channel, and
in a time period in which communication is being executed with a first communication apparatus using the second channel access method, in a case where the Primary channel becomes available for use, executing a first control to transition an operating status of the communication apparatus for the Primary channel to a predetermined status, a second control to transition a status of the Primary channel to a predetermined status, a third control to transmit a predetermined signal to the first communication apparatus executing communication using the Non-Primary channel, or fourth control to end communication with the first communication apparatus executed using the second channel access method.

2. The communication apparatus according to claim 1, wherein
the first channel access method is a Primary channel access method of accessing a channel based on a result of carrier sense of the Primary channel, and
the second channel access method is a Non-Primary channel access method of accessing a channel based on a result of carrier sense of the Non-Primary channel.

3. The communication apparatus according to claim 1, wherein
the Primary channel is a Primary channel specified based on one standard from among IEEE 802.11 standard series, and
the Non-Primary channel is a Non-Primary channel specified based on at least one standard from among IEEE 802.11 standard series.

4. The communication apparatus according to claim 1, wherein
the executing of control includes, in a time period in which communication using the second channel access method is being executed, executing the first control, the second control, the third control, or the fourth control based on a busy state of the Primary channel ending.

5. The communication apparatus according to claim 1, the operations further comprising:
detecting that the Primary channel has become available for use in a case where a completion signal for terminating a Network Allocation Vector set for the Primary channel is detected.

6. The communication apparatus according to claim 5, wherein
the detecting includes detecting the completion signal transmitted using a Contention Free- (CF-)END frame specified in IEEE 802.11 standard series.

7. The communication apparatus according to claim 1, wherein
the executing of control includes, as the first control, transitioning the operating status of the communication apparatus for the Primary channel from power save operation to normal operation.

8. The communication apparatus according to claim 1, wherein
the executing of control includes, as the first control, executing control to, while the communication apparatus is receiving a signal from the first communication apparatus using the second channel access method, transition the operating status of the communication apparatus for the Primary channel to a status in which a signal having the communication apparatus as a destination and transmitted using the Primary channel by a second communication apparatus different from the first communication apparatus can be received.

9. The communication apparatus according to claim 1, wherein
the executing of control includes, as the first control, executing control to, while the communication apparatus is transmitting a signal to the first communication apparatus using the second channel access method, transition the operating status of the communication apparatus for the Primary channel to a status in which a signal can be transmitted to a second communication apparatus different from the first communication apparatus using the Primary channel.

10. The communication apparatus according to claim 1, wherein
the executing of control includes, as the second control, executing control to transition to a reserved status in which use of the Primary channel is reserved.

11. The communication apparatus according to claim 10, wherein
the executing of control includes executing control for the communication apparatus to transmit a reserve signal including a reserve period for the Primary channel set based on a time period in which communication is being executed with the first communication apparatus using the second channel access method.

12. The communication apparatus according to claim 10, wherein
the executing of control includes reserving use of the Primary channel by transmitting a Clear-to-Send- (CTS-) to-Self frame specified in IEEE 802.11 standard series.

13. The communication apparatus according to claim 1, wherein
the executing of control includes, as the third control, executing control to, while the communication apparatus is receiving a signal from the first communication apparatus using the second channel access method, transmit a notification that the Primary channel has become available for use or an instruction to end transmission using the second channel access method to the first communication apparatus.

14. The communication apparatus according to claim 13, wherein
the executing of control includes transmitting the notification or the instruction using a response to a signal from the first communication apparatus.

15. The communication apparatus according to claim 13, wherein
the executing of control includes transmitting the notification or the instruction using a link different from the link.

16. The communication apparatus according to claim 1, wherein
the executing of control includes, as the fourth control, controlling the communication apparatus to, in a case where the Primary channel has become available for use in a transmission period for communication executed by the communication apparatus using the second channel access method, end the transmission period for communication executed using the second channel access method.

17. A communication method executed by a communication apparatus that performs communication compliant with IEEE 802.11 standard series with another communication apparatus using a first channel access method that uses at least a Primary channel of one link and a second channel access method that, in a case where the Primary channel is in a busy state, uses a Non-Primary channel different from the Primary channel from among a plurality of channels included in the link and does not use the Primary channel, the communication method comprising:
in a time period in which communication is being executed with a first communication apparatus using the second channel access method, in a case where the Primary channel becomes available for use, executing a first control to transition an operating status of the communication apparatus for the Primary channel to a predetermined status, a second control to transition a status of the Primary channel to a predetermined status, a third control to transmit a predetermined signal to the first communication apparatus executing communication using the Non-Primary channel, or fourth control to end communication with the first communication apparatus executed using the second channel access method.

18. A non-transitory computer readable storage medium that stores a program that causes, when the program is executed, a communication apparatus, which performs communication compliant with IEEE 802.11 standard series with another communication apparatus using a first channel access method that uses at least a Primary channel of one link and a second channel access method that, in a case where the Primary channel is in a busy state, uses a Non-Primary channel different from the Primary channel from among a plurality of channels included in the link and does not use the Primary channel, to perform:
in a time period in which communication is being executed with a first communication apparatus using the second channel access method, in a case where the
Primary channel becomes available for use, executing a first control to transition an operating status of the communication apparatus for the Primary channel to a predetermined status, a second control to transition a status of the Primary channel to a predetermined status, a third control to transmit a predetermined signal to the first communication apparatus executing communication using the Non-Primary channel, or fourth control to end communication with the first communication apparatus executed using the second channel access method.
